(19) United States
(12) Patent Application Publication
(10) Pub. No.: US 2021/0008844 A1
(43) Pub. Date: Jan. 14, 2021

(54) HEATED LAMINATE WITH IMPROVED AESTHETIC

(71) Applicant: AGP America S.A., Ciudad de Panamá (PA)

(72) Inventors: Mario Arturo MANNHEIM ASTETE, Lima (PE); Charles Stephen VOELTZEL, Lima (PE)

(21) Appl. No.: 16/979,989

(22) PCT Filed: Mar. 12, 2019
(86) PCT No.: PCT/IB2019/052015

§ 371 Date: Sep. 11, 2020

Related U.S. Application Data
(60) Provisional application No. 62/641,900, filed on Mar. 12, 2018.
(60) Provisional application No. 62/641,916, filed on Mar. 12, 2018.

(51) Int. Cl. B32B 17/10

(52) U.S. Cl. CPC B32B 17/10055; H05B 3/86; B32B 17/10293; B32B 17/10174

(57) ABSTRACT

Heated windshields, which utilize a transparent conductive coating, are increasing in popularity due to the rapid deice defog action and higher efficiency of such products. With the limited waste heat available in electric and hybrid electric vehicles, cabin heating and defrosting must be done with electric power. One of the problems in designing a heated windshield is hiding the busbars from view for the exterior of the vehicle. This is especially a problem when the coating is on the inner surface of the exterior glass layer which is the preferred embodiment for both solar control and defrosting. The normal black obscuration cannot be applied over the coating and it is very expensive to first paint and then coat the glass. The invention makes use of a thin conductive layer placed between the bus bars and the coating which serves to hide the bus bars from view providing a glazing with an improved aesthetic.

### FIELD OF THE INVENTION

The invention relates to the field of electrically heated laminated automotive glazing.

### BACKGROUND OF THE INVENTION

In response to the regulatory requirements for increased automotive fuel efficiency as well as the growing public awareness and demand for environmentally friendly products, automotive Original Equipment Manufacturers (OEM), around the world, have been working to improve the efficiency of their vehicles.

The typical internal combustion engine (ICE) powered vehicle is not extremely efficient at turning the energy from the fuel into kinetic energy. More of the energy is converted into heat than motion. Managing this waste heat has long been one of the major challenges faced in the design of this type of vehicle. However, one of the benefits of this inefficiency is that it provides a ready and essentially free source of power for heating the cabin and clearing the glazing of ice and fog. The typical ICE vehicle is equipped with a hot air system with a heat exchanger having a capacity of 4,000 watts or greater. This compares to the 1,000-1,500-watt capacity of the typical automotive electrical alternator. Another point of reference is an electric hand-held hair dryer with typically consumes 1600 watts.

However, as the efficiency of ICE vehicles has increased, some high efficiency, small displacement engine vehicles, especially those sold in parts of the world with a cold climate, have had to add resistive heating elements to provide sufficient cabin heat. One advantage of resistive heating is that the heat is provided on demand. There is no lag waiting for the engine heat up. A typical approach has been to add positive temperature coefficient resistive heating elements, which are self-regulating and inexpensive, to the hot air system to supplement to the air/liquid heat exchanger.

The move towards hybrid-electric and all-electric vehicles has further increased the need for resistive heating. With an all-electric battery powered drive train, only limited waste heat is available from the battery pack. While many hybrids may be equipped with an ICE to supplement and charge the battery the engine tends to be small, very efficient and is often not operated continuously while the vehicle is in use. This is also a problem even in non-electric ICE vehicles which utilize engine start/stop technology where the engine shuts off when the vehicle is not in motion. During a long stop in traffic, there may not be enough heat available to maintain the cabin temperature and to keep the glazing clear.

The primary problem with resistive heating is the large amount of energy that it can consume. This is especially important for all-electric vehicles where cold weather can significantly reduce range due to the demands of the cabin heating and deice/defog system. As an example, an electric vehicle with a battery capacity of 40 kW hours, operating a 4,000 watt hot air system for just one hour would use 10% of its capacity and have its range reduced by 10% contributing to what has been called range anxiety.

As the industry also simultaneously moves towards semi and full autonomous operation, rapid clearing of the windshield, where essential components of the autonomous hardware are mounted, has become even more important. This is essential for a fast drive away time.

Most vehicles are equipped with hot air windshield defrosting systems. For windshield defogging and deicing, a hot air blower system is not very effective. Only a small percentage of the energy from the hot air is transferred to the glass. Even with a large heat capacity, it can take a significant amount of time to clear the windshield. Some vehicles are produced which have full windshield resistive heating. By locating the resistive heating element inside of the laminate, the energy efficiency is improved by a large factor. Other than some minor convective losses, most of the energy is absorbed by the glass and the water or ice.

As can be appreciated, the closer that the resistive element is to the ice, the faster and more efficient the element will be. The ideal would be to have the resistive element on the exterior surface 101 of the laminate (FIG. 1A). However, coatings are not available that have the durability needed to hold up to direct exposure to the elements, wiper blades, snow brushes and ice scrapers. The inside surface 102 of the outer glass layer 201 is the best compromise where the heat only needs to pass through a single layer of glass. For practical and cost reasons, the coating is sometimes applied to the side for the inner glass layer 202 that faces the exterior 103. The heat then needs to pass through the plastic interlayer 4 to reach the outer glass layer 201. The drawbacks are that more of the heat is transferred to the interior glass layer than to the exterior and that the plastic is a good insulator.

The number two surface 102 is also the preferred surface for solar control coatings which are also often conductive and use for heated applications as well. These products work by reflecting the heat of the sun back into the atmosphere. Therefore, the ideal would be to place the coating on the exterior surface of the laminate. As is the case with transparent conductive coatings, there are no solar control coating that have the durability needed. Therefore, the best compromise is the number two surface 102 on the outer glass layer 201. There, the energy from the sun passes through the glass a first time, is reflected back, and then passes through the glass a second time. Some of the energy will be absorbed by the glass causing the glass surface temperature to increase and subsequently for the energy absorbed to be transferred to the cabin by convective and radiant transfer. If the coating is on the number three surface 103, then the energy must also pass through the plastic interlayer twice which results in even more energy being transferred to the passenger compartment.

Resistive heating circuits have been available for automotive glazing for many years. They are commonly provided on automotive rear windows (backlites) to assist vision and enhance safety by melting snow and ice and clearing fog. Resistive heating is the only option that is practical for a backlite. The location of the backlite does not allow it to take advantage of the hot-air system used for the windshield. It would be impractical and expensive to route hot air or heated fluid to a secondary heat exchanger and blower system for clearing the backlite. Prior to the introduction of resistive heating circuits, during bad weather, the backlite would sometimes never clear with just the circulating cabin hot air.

Printed silver frit is the most common type of heated circuit used for backlites Fine silver powder is mixed with solvents, carriers, binders and finely ground glass. Other materials are also sometimes added to enhance certain properties: the firing temperature, bleed through, anti-stick, chemical resistance, etc. The silver frit is applied to the glass using a silk screen or ink jet printing process prior to the heating and bending of the glass. As the flat glass is heated during the bending process, the powdered glass in the frit softens and melts, fusing to the surface of the glass. The silver frit print becomes a permanent part of the glass. The frit is said to be “fired” when this takes place. This is a vitrification process which is very similar to the process used to apply enamel finishes on bathroom fixtures, pottery, china and appliances. Sheet resistances as low as 2 milliohms per square and line widths as narrow as 0.5 mm are possible. The primary drawback to silver print is the aesthetics of the fired silver which has a dark orange to mustard yellow color depending upon which side of the glass it is printed on, the air side or the tin side. Busbars are also printed silver but may be reinforced electrically with copper strips or braids.

Printed silver frit heated circuits are also used on some windshields. On vehicles that have wipers that are hidden below the hood line when not in use, a heated wiper rest area is needed to keep the wipers clear of snow and ice when not in use and to prevent the buildup of snow in ice in the rest area when in use. Windshields that have safety cameras also require a heated circuit that can quickly clear the portion of the windshield in the camera field of view.

Screen print silver circuits cannot be used on the windshield in the vision areas as the lines are too wide and would interfere with vision.

Thins wires have been used as resistive elements in windshields and laminated backlites. An embedded wire resistive heated circuit is formed by embedding fine wires into the plastic bonding layer of a laminate. The wires are embedded in the plastic using heat or ultra-sound utilizing a CNC machine. Tungsten is a preferred material due to its tensile strength, which is 10× that of Copper, and its flat black color. Heated windshields typically use tungsten wire that is in the 18-22 μm range at which point the wires are virtually invisible. The wires are embedded using an oscillating sinusoidal like pattern to reduce the glare that can occur under certain lighting conditions. For positions of the glazing other than the windshield, larger wire diameters can be used. Thin flat copper is used for busbars with two layers being typically used. The first layer is applied to the plastic layer prior to the embedding of the wires. The wires are embedded such that they overlap the first layer. The second layer is then applied over top of the first layer and the two are joined by soldering or with the use of conductive adhesive. For some applications it may only be required to use a single layer of copper. Of course, conductors other than copper and tungsten can be used.

While wire heated windshields have been produced in large quantities for many years, acceptance has been limited. Even at a diameter of 18 μm, the wires are visible under certain lighting conditions. Due to the limited power that can be achieved with a 12-volt electrical system, they do not develop that power needed for rapid deicing. The added cost is also relatively high. Very few vehicles have a wire heated windshield available as an option. Some automotive OEMs do not offer wire heated windshields on any models for these reasons.

A number of transparent conductive coatings, many of which were developed for solar control, are available which can be used for windshield heating.

Automotive glazing often makes use of heat absorbing glass compositions to reduce the solar load on the vehicle. While a heat absorbing window can be very effective the glass will heat up and transfer energy to the passenger compartment through convective transfer and radiation. A more efficient method is to reflect the heat back to the atmosphere allowing the glass to stay cooler. This is done using various infrared reflecting films and coatings. Infrared coatings and films are generally too soft to be mounted or applied to a glass surface exposed to the elements. Instead, they must be fabricated as one of the internal layers of a laminated product to prevent damage and degradation of the film or coating.

Infrared reflecting coatings include but are not limited to the various metal/dielectric layered coatings applied though Magnetron Sputtered Vacuum Deposition (MSVD) as well as others known in the art that are applied via pyrolytic, spray, controlled vapor deposition (CVD), dip and other methods.

In addition to coatings on glass, transparent conductive infrared reflecting coatings are also applied to thin plastic substrates such as PET to form films which can then be incorporated into a laminate.

Infrared reflecting films include both metallic coated plastic substrates as well as organic based non-metallic optical films which reflect in the infrared. Most of the infrared reflecting films are comprised of a plastic film substrate having an infrared reflecting layered metallic coating applied. Films require an additional plastic interlayer sheet to bond the opposite side of the film to the glass.

Silver based solar control coatings are very reactive and need to be protected from exposure to the elements. Therefore, they are not suitable for use on the exposed surfaces of a laminate. Rather they must be applied to the number two or number three surfaces of a standard two glass layer automotive laminate.

If the coating is allowed to extend to the edge of the laminate, the coating will slowly over time, deteriorate as the silver reacts with water and the atmosphere. To prevent this the coating must not extend to the edge or the edge must be sealed.

The more common approach is to delete the coating in this area. As the coating is soft, an abrasive can be used to remove the coating without damaging the glass surface. A typical means is a motorized spinning abrasive wheel mounted on a CNC machine which can trace the path. Abrasion deletion is done before cutting as the raw edge of the glass would quickly wear out the abrasive wheel. Abrasive wheel deletion is available as an option on many glass cutting machines where an additional head is added which can be swapped with the cutting head allowing the deletion and cutting to be done on the same machine.

Another method used is masking. Before the coating is applied, a mask is used to prevent the application of coating to the areas of interest. After coating the masking is removed. The large magnetron sputter vacuum deposition coaters need to apply the complex stack of a double or triple silver coating are major capital investments making masking impractical for most windshield fabrication lines. Where MSVD coaters are available, another advantage is that the glass can also be painted and fired with black frit prior to coating to hide the edge of the deletion. This is especially advantageous when fabricating a conductive coating based heated laminate as the coating can be applied to the number two surface, placing it closer to the surface that needs to be deiced and silver frit bus bars can also be printed and fired prior to coating.

LASERs can also be used for coating deletion but are not generally used for large area or edge deletion just due to large capital expense of a LASER based deletion system. Full surface windshield heating can be provided thought the use of these conductive transparent coatings and films. The coating is vacuum sputtered directly onto the substrate and is comprised of multiple layers of metal and dielectrics. With resistances in the range of 2-6 ohms per square, a voltage convertor is needed to reach the power density required. Busbars are comprised of printed silver frit, applied and fired prior to coating or thin flat copper conductors which are added during lamination. A combination of the silver frit and thin flat metal bus bars may also be used.

When designing a heated windshield, the preferred location for the resistive heating element, as discussed, is on the number two surface 102. The problem that this can present is in hiding the bus bars. The bus bars must make good electrical contact with the coating. If an obscuration is applied over the coating, then the bus bars cannot make electrical contact. To coat over the black obscuration, the glass must first be painted and fired and then passed through a coater. There are many reasons why this is not commonly done. The primary one is that the type of coater needed to economically produce serial production automotive sized parts is very large, measured in the 10s of millions of dollars. Likewise, this is a very large piece of equipment requiring a major investment in a structure to house it. Very few heated windshields are made with the resistive heating element on the number two surface. In addition, when designing a heated windshield, additional challenges include the fact that the supply voltage and the available power are fixed, the bus bar locations are limited and there are a limited number of coating available and the range of sheet resistance for each coating is limited. As a result, for a given windshield configuration and a given coating, there is little that can be done to design the heated circuit to meet a certain target power consumption. The tendency is for the windshield to draw more power than desired when working with silver coatings in the 1-5 ohm/square range. Also, as most windshields tend to be wider at the bottom than that top, these types of windshield tend to heat unevenly, with a lower power density at the bottom, along the longer bus bar than at the top.

It would be desirable to overcome these limitations. In particular, it would be desirable to be able to produce a heated windshield, with a number two surface resistive element and hidden bus bars, without investing in a coater.

### BRIEF SUMMARY OF THE INVENTION

It is an object of the invention to provide a thin layer of a conductive material which is placed between the bus bars and the conductive coating. The conductive material used is selected such that is will complement the aesthetics of the laminate. This material can be comprised of a number of conductive materials and composites utilizing various conductive materials such as metals and forms of Carbon. Graphite, has been found to work well in this capacity. Graphite is available in thin sheets. The electrical and thermal conductivity of graphite lend themselves well to this application. The dark grey appearance hides the bus bars and give the laminate a high-tech look. The Graphite can be shaped to mimic the appearance of a black band or to complement a black obscuration on another layer of the laminate. To further improve the aesthetics of the laminate, the graphite can have a pattern printed on it. An exampled would be a weave pattern giving the graphite the appearance of carbon fiber. An added benefit is that the soft graphite isolates the metal of the bus bar from the coating, preventing the coating from cutting into or gouging the coating which can lead to arcing, hot spots and cold spots and in general making for a longer life and better performance. While graphite has been found to work well, the invention is not limited to graphite. Any equivalent material that serves the same purpose may be substituted.

### BRIEF DESCRIPTION OF THE SEVERAL VIEWS OF THE DRAWINGS

These features and advantages of the present invention will become apparent from the detailed description of the following embodiments in conjunction with the accompanying drawings, wherein:

FIG. 1A shows a cross section of a typical automotive laminate.

FIG. 1B shows a cross section of a typical automotive laminate having a performance film.

FIG. 2 shows a hated laminate having a conductive coating with graphite between busbar and coating.

FIG. 3 shows the top view of heated laminate with graphite between bus bar and number two surface conductive transparent coating.

FIG. 4 shows an exploded view of heated laminate with graphite between bus bar and number two surface conductive transparent coating.

FIG. 5 shows an exploded view of heated laminate with conductive material between bus bar and number two surface conductive transparent coating wherein busbars and conductive material are notched.

FIG. 6A shows a conductive coating with notched busbar and conductive material.

FIG. 6B shows a conductive coating with notches and busbar and conductive material.

### REFERENCE NUMERALS OF DRAWINGS

2 Glass

4 Bonding/Adhesive Layer (interlayer)

6 Obscuration/Black Frit

20 Bus bar

22 Conductive material (graphite)

24 Conductive coating

28 Coating deletion

32 Power connector

44 Performance film

46 Tabs

48 Discontinuities

101 Surface one

102 Surface two

103 Surface three

104 Surface four

201 Outer layer

202 Inner layer

### DETAILED DESCRIPTION OF THE INVENTION

The following terminology is used to describe the laminated glazing of the invention.

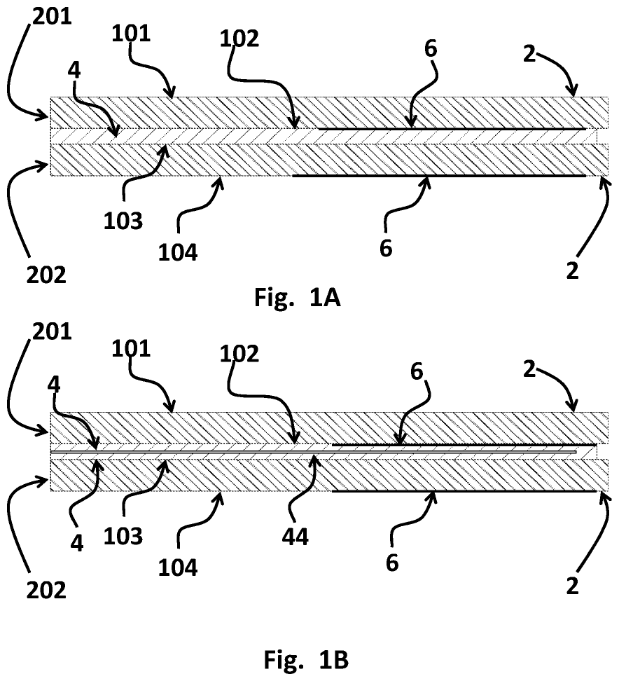

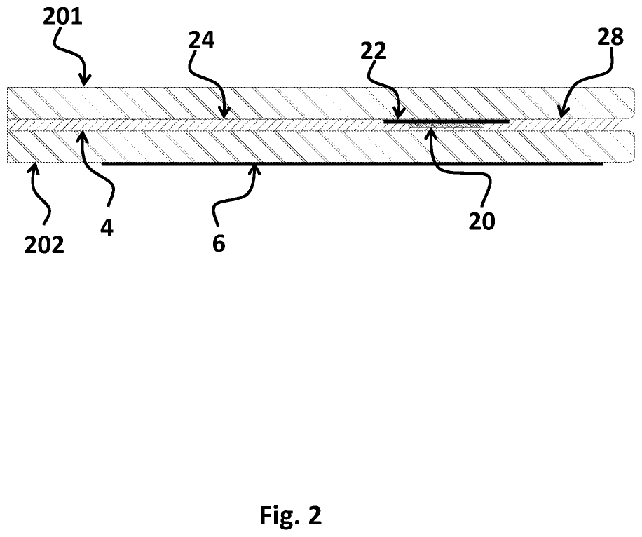

A typical automotive laminate cross section is illustrated in FIGS. 1A and 1B. The laminate is comprised of two layers of glass, the exterior or outer 201 and interior or inner 202 that are permanently bonded together by a plastic layer 4 (interlayer). The glass surface that is on the exterior of the vehicle is referred to as surface one 101 or the number one surface. The opposite face of the outer glass layer 201 is surface two 102 or the number two surface. The glass surface that is on the interior of the vehicle is referred to as surface four 104 or the number four surface. The opposite face of the inner layer of glass 202 is surface three 103 or the number three surface. Surfaces two 102 and three 103 are bonded together by the plastic layer 4. An obscuration 6 may be also applied to the glass. Obscurations are commonly comprised of black enamel frit printed on either the number two 102 or number four surface 104 or on both. The laminate may also comprise a coating 24 on one or more of the surfaces. The laminate may also comprise a performance film 44 laminated between at least two plastic layers 4.

This black frit print obscuration 6 on many automotive glazings serves both a functional and an aesthetic role. The substantially opaque black print on the glass serves to protect the poly-urethane adhesive, used to bond the glass to the vehicle, from ultra-violet light and the degradation that it can cause. It also serves to hide the adhesive from view from the exterior of the vehicle. The black obscuration must be durable, lasting the life of the vehicle under all exposure and weather conditions. Part of the aesthetic requirement is that the black have a dark glossy appearance and a consistent appearance from part to part and over the time. A part produced today must match up with one that was produced and in service 20 years ago. The parts must also match up with the other parts in the vehicle which may not have been fabricated by the same manufacturer or with the same formulation of frit. Standard automotive black enamel inks (frits) have been developed that can meet these requirements.

Black enamel frit is comprised of pigments, carriers, binders and finely ground glass. Other materials are also sometimes added to enhance certain properties: the firing temperate, anti-stick, chemical resistance, etc. The black frit is applied to the glass using a silk screen or ink jet printing process prior to the heating and bending of the glass. As the flat glass is heated during the bending process, the powdered glass in the frit softens and melts, fusing to the surface of the glass. The black print becomes a permanent part of the glass. The frit is said to be “fired” when this takes place. This is a vitrification process which is very similar to the process used to apply enamel finishes on bathroom fixtures, pottery, china and appliances.

The types of glass 2 that may be used include but are not limited to: the common soda-lime variety typical of automotive glazing as well as aluminosilicate, lithium aluminosilicate, borosilicate, glass ceramics, and the various other inorganic solid amorphous compositions which undergo a glass transition and are classified as glass included those that are not transparent. The glass layers may be comprised of heat absorbing glass compositions as well as infrared reflecting and other types of coatings.

Most of the glass used for containers and windows is soda-lime glass. Soda-lime glass is made from sodium carbonate (soda), lime (calcium carbonate), dolomite, silicon dioxide (silica), aluminum oxide (alumina), and small quantities of substances added to alter the color and other properties.

Borosilicate glass is a type of glass that contains boric oxide. It has a low coefficient of thermal expansion and a high resistance to corrosive chemical. It is commonly used to make light bulbs, laboratory glassware, and cooking utensils.

Aluminosilicate glass is make with aluminum oxide. It is even more resistant to chemicals than borosilicate glass and it can withstand higher temperatures. Chemically tempered Aluminosilicate glass is widely used for displays on smart phones and other electronic devices.

Laminates, in general, are articles comprised of multiple sheets of thin, relative to their length and width, material, with each thin sheet having two oppositely disposed major faces and typically of relatively uniform thickness, which are permanently bonded to one and other across at least one major face of each sheet.

Laminated safety glass is made by bonding two sheets 201, 202 of annealed glass 2 together using a plastic bonding layer comprised of a thin sheet of transparent thermos plastic 4 (interlayer) as shown in FIG. 1.

A wide variety of films are available that can be incorporated into a laminate. The uses for these films include but are not limited to: solar control, variable light transmission, increased stiffness, increased structural integrity, improved penetration resistance, improved occupant retention, providing a barrier, tint, providing a sunshade, color correction, and as a substrate for functional and aesthetic graphics. The term “film” shall include these as well as other products that may be developed or which are currently available which enhance the performance, function, aesthetics or cost of a laminated glazing. Most films do not have adhesive properties. To incorporate into a laminate, sheets of plastic interlayer are needed on each side of the film to bond the film to the other layers of the laminate. Any film which incorporates a conductive layer has the potential to also be used to add a resistive heated circuit to the laminate in addition to its other function.

Annealed glass is glass that has been slowly cooled from the bending temperature down through the glass transition range. This process relieves any stress left in the glass from the bending process. Annealed glass breaks into large shards with sharp edges. When laminated glass breaks, the shards of broken glass are held together, much like the pieces of a jigsaw puzzle, by the plastic layer helping to maintain the structural integrity of the glass. A vehicle with a broken windshield can still be operated. The plastic layer 4 also helps to prevent penetration by objects striking the laminate from the exterior and in the event of a crash occupant retention is improved.

The glass layers may be annealed or strengthened. There are two processes that can be used to increase the strength of glass. They are thermal strengthening, in which the hot glass is rapidly cooled (quenched) and chemical tempering which achieves the same effect through an ion exchange chemical treatment.

Heat strengthened, full temper soda-lime float glass, with a compressive strength in the range of at least 70 MPa, can be used in all vehicle positions other than the windshield. Heat strengthened (tempered) glass has a layer of high compression on the outside surfaces of the glass, balanced by tension on the inside of the glass which is produced by the rapid cooling of the hot softened glass. When tempered glass breaks, the tension and compression are no longer in balance and the glass breaks into small beads with dull edges. Tempered glass is much stronger than annealed laminated glass. The thickness limits of the typical automotive heat strengthening process are in the 3.2 mm to 3.6 mm range. This is due to the rapid heat transfer that is required. It is not possible to achieve the high surface compression needed with thinner glass using the typical blower type low pressure air quenching systems.

In the chemical tempering process, ions in and near the outside surface of the glass are exchanged with ions that are larger. This places the outer layer of glass in compression. Compressive strengths of up to 1,000 MPa are possible. The typical methods involved submerging the glass in a tank of molten salt where the ion exchange takes place. The glass surface must not have any paint or coatings that will interfere with the ion exchange process.

The glass layers are formed using gravity bending, press bending, cold bending or any other conventional means known in the art. In the gravity bending process, the glass flat is supported near the edge of glass and then heated. The hot glass sags to the desired shape under the force of gravity. With press bending, the flat glass is heated and then bent on a full of partial surface mold. Air pressure and vacuum are often used to assist the bending process. Gravity and press bending methods for forming glass are well known in the art and will not be discussed in detail in the present disclosure.

Cold bending is a relatively new technology. As the name suggest, the glass is bent, while cold to its final shape, without the use of heat. On parts with minimal curvature a flat sheet of glass can be bent cold to the contour of the part. This is possible because as the thickness of glass decreases, the sheets become increasingly more flexible and can be bent without inducing stress levels high enough to significantly increase the long-term probability of breakage. Thin sheets of annealed soda-lime glass, in thicknesses of about 1 mm, can be bent to large radii cylindrical shapes (greater than 6 m). When the glass is chemically, or heat strengthened the glass can endure much higher levels of stress and can be bent along both major axis. The process is primarily used to bend chemically tempered thin glass sheets (<=1 mm) to shape.

Cylindrical shapes can be formed with a radius in one direction of less than 4 meters. Shapes with compound bend, that is curvature in the direction of both principle axis can be formed with a radius of curvature in each direction of as small as approximately 8 meters. Of course, much depends upon the surface area of the parts and the types and thicknesses of the substrates.

The cold bent glass will remain in tension and tend to distort the shape of the bent layer that it is bonded to. Therefore, the bent layer must be compensated to offset the tension. For more complex shapes with a high level of curvature, the flat glass may need to be partially thermally bent prior to cold bending.

The glass to be cold bent is placed with a bent to shape layer and with a bonding layer placed between the glass to be cold bent and the bent glass layer. The assembly is placed in what is known as a vacuum bag. The vacuum bag is an airtight set of plastic sheets, enclosing the assembly and bonded together it the edges, which allows for the air to be evacuated from the assembly and which also applies pressure on the assembly forcing the layers into contact. The assembly, in the evacuated vacuum bag, is then heated to seal the assembly. The assembly is next placed into an autoclave which heats the assembly and applies high pressure. This completes the cold bending process as the flat glass at this point has conformed to the shape of the bent layer and is permanently affixed. The cold bending process is very similar to a standard vacuum bag/autoclave process, well known in the art, except for having an unbent glass layer added to the stack of glass.

The plastic bonding layer 4 (interlayer) has the primary function of bonding the major faces of adjacent layers to each other. The material selected is typically a clear thermoset plastic.

For automotive use, the most commonly used bonding layer 4 (interlayer) is polyvinyl butyral (PVB). PVB has excellent adhesion to glass and is optically clear once laminated. It is produced by the reaction between polyvinyl alcohol and n-butyraldehyde. PVB is clear and has high adhesion to glass. However, PVB by itself, it is too brittle. Plasticizers must be added to make the material flexible and to give it the ability to dissipate energy over a wide range over the temperature range required for an automobile. Only a small number of plasticizers are used. They are typically linear dicarboxylic esters. Two in common use are di-n-hexyl adipate and tetra-ethylene glycol di-n-heptanoate. A typical automotive PVB interlayer is comprised of 30-40% plasticizer by weight.

In addition to polyvinyl butyl, ionoplast polymers, ethylene vinyl acetate (EVA), cast in place (CIP) liquid resin and thermoplastic polyurethane (TPU) can also be used. Automotive interlayers are made by an extrusion process with has a thickness tolerance and process variation. As a smooth surface tends to stick to the glass, making it difficult to position on the glass and to trap air, to facilitate the handling of the plastic sheet and the removal or air (deairing) from the laminate, the surface of the plastic is normally embossed contributing additional variation to the sheet. Standard thicknesses for automotive PVB interlayer at 0.38 mm and 0.76 mm (15 and 30 mil).

A laminate must have at least one interlayer. More than one is required if the laminate also comprises a film. Multiple interlayers are also sometimes used to alter the light transmittance of a laminate and to correct for optical aberrations.

The typical conductive coated heated windshield utilizes busbars that are in contact with the coating substantially across their entire length. One exception is where there is a coating deletion 28 or oblation to accommodate a rain sensor, camera or other device which will not operate in the presence of the coating. In this special case, the bus bar 20 will sometimes extend below the deletion area.

The bus bar is typically comprised of thin (5075 μm) tinned copper cut to shape. The bus bar may utilize a conductive adhesive to adhere to the coating or may just be placed in direct contact with the coating with no adhesive. A common approach is to apply a non-conductive contact adhesive to the side of the bus bar that does not come into contact with the coating and then to apply the bus bars to the interlayer prior to lamination. This can be done in advance and offline, spreading up the final assembly of the laminate.

For very thin conductive materials we typical characterize the resistance in terms of the sheet resistance. The sheet resistance is the resistance that a rectangle, with perfect bus bar on two opposite sides, would have. Sheet resistance is specified in ohms per square. This is a dimensionally unitless quantity as it is not dependent upon the size of the rectangle. The bus bar to bus bar resistance remains the same regardless of the size of the rectangle.

The copper bus bars, due to the difference between the coefficient of thermal expansion of the copper and the glass, have a tendency to not lay flat on the glass. Over time, they also have a tendency to discolor as the metal reacts with the moisture in the interlayer. For these reasons, they do not present an acceptable aesthetic and must be hidden.

Rather than applying the bus bars directly to the coating, a thin aesthetically acceptable conductive material is first placed in contact with the coating. The bus bar is then placed in contact with the thin conductive material. The conductive material must be sufficiently larger than the bus bar so as to obscure if from view from the exterior of the vehicle. The thin conductive material may be substantially larger and even mimic the black band.

The heated laminated could have a conductive coating deposited directly onto a glass substrate or a plastic substrate in the case of a film. In the case of a film, an additional plastic interlayer layer is required for lamination.

In the other hand, the power consumption and distribution must often be compromised as many of the design parameters either set or can only be varied over a narrow range.

Being the thin aesthetic conductive material first placed in contact with the coating, and the bus bar then placed in contact with the thin aesthetic conductive material, the shape of both together and/or the conductive coating also could be altered such that the electrical connection between the bus bar through the conductive material and the coating is not continuous along the entire length of at least one of the bus bars. This in effect removes portions of the coating from the circuit, increasing the bus to bus overall resistance and lowering the total power. This also allows for tailoring of the power density.

The bus to bus resistance is a function of the conductive coating sheet resistance and the bus bar spacing. For a typical windshield, with bus bars running across the top and bottom, it is possible to get a power density in the 15-20 watt/dm2 range with a double silver coating and a 42-volt power supply. This may be too high. On an annealed glass part, we need to take care that the glass is not thermally shocked which can occur at this power level. The other constraint is available power. As the capacity of the power converter increases so does the weight and cost. The battery and alternator must also be able to handle the power required. Due to the large area of many windshields and the constraint on the design as discussed, it is possible to have a windshield that will draw more power than required or available. This is especially true if the design is also intended to maximize solar performance by using a highly conductive silver-based coating.

To correct this situation, the conductive material and the bus bar together to conductive coating interface could be modified such that power is not feed along the entire length of at least one of the bus bars. Discontinuities could be provided to break the flow of current from the bus bars to the coating. The actual number of and dimensions of the discontinuities could be determined through computer or physical modeling. In general, the less the area in contact, the higher the resistance. But, the relative locations of the discontinuities along each of the bus bars relative to each other are also important. The discontinuities may be arranged but are not limited to: overlapping, staggered or aligned or in any combination. The spacing may be uniform or non-uniform. The discontinuities may be symmetrical or nonsymmetrical.

The flow of current is influenced by the length and spacing of the discontinuities. If the spacing is too short, the effect on the resistance will be negligible. The length of each discontinuity and the spacing between should be at least 2.5% of the average distance between the opposite bus bars. If the spacing is to great, then we can have the opposite effect with areas of the windshield left without power. The length of each discontinuity and the spacing between should be no more than 20% of the average distance between the opposite bus bars. These percentages will vary with the relative location of the discontinuities on opposite bus bars to each other and is intended as a general rule of thumb to guide the initial design. It may be required to use a value that it less than or greater than the minimum and maximum.

A number of methods may be used to produce the discontinuities of the invention.

### Description of Embodiments

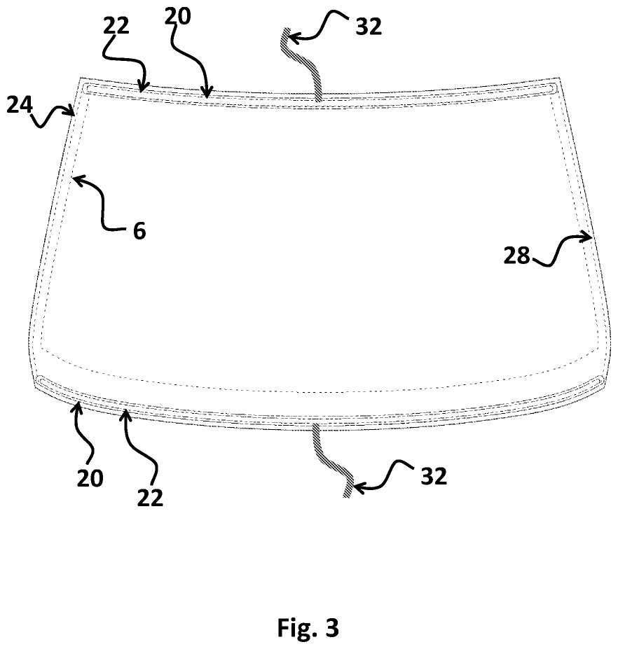

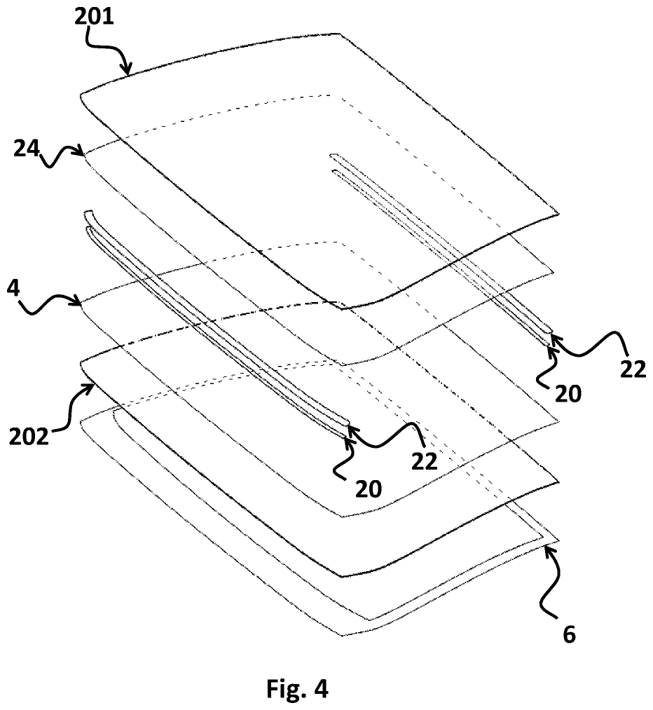

1. The laminate of embodiment one is illustrated in the exploded view of FIG. 4 and in the top view of FIG. 3. The outer glass layer 201 is comprised of 2.1 mm thick clear soda-lime glass. A conductive layer is formed by a silver based MSVD coating 24 applied to the flat outer glass layer 201 prior to cutting and bending. An abrasive wheel process is used to delete the conductive coating 24 starting at the edge of glass and extending to 6 mm inboard of the edge of glass. The outer 201 glass sheet is then cut to size. The inner glass layer 202 is comprised of a clear 2.1 mm thick soda-lime glass. A black frit obscuration 6 is printed on the number four surface. The two glass layers are heated and bent to shape. A sheet of 50 μm thick graphite is cut to the size of the bus bars plus an additional 6 mm. The cut graphite 22 is then placed in contact with the conductive coating 24. No adhesive is used. A set of bus bars 20 comprised of 0.075 mm thick tinned copper are die cut to shape and applied to the graphite 22. Again, no adhesive is used. The coated outer glass layer 201, the uncoated inner glass layer 202, a sheet of 0.76 mm PVB plastic interlayer 4, the graphite 22 and the bus bars 20 are assembled. A standard autoclave process is used to laminate the layers.
2. The laminate of embodiment two is illustrated in the exploded view of FIG. 4 and in the top view of FIG. 3. The outer glass layer 201 is comprised of 2.1 mm thick clear soda-lime glass. A conductive layer 24 is formed by a silver based MSVD coating applied to the flat outer glass layer 201 prior to cutting and bending. An abrasive wheel process is used to delete the conductive coating 24 starting at the edge of glass and extending to 6 mm inboard of the edge of glass. The outer 201 glass sheet is then cut to size. The inner glass layer 202 is comprised of a clear 0.7 mm thick chemically tempered aluminosilicate glass. A black frit obscuration 6 is printed on the number four surface. The two glass layers are heated and bent to shape. A sheet of 50 μm thick graphite 22 is cut to the size of the bus bars 20 plus an additional 6 mm. The cut graphite 22 is then placed in contact with the conductive coating 24. No adhesive is used. A set of bus bars 20 comprised of 0.075 mm thick tinned copper are die cut to shape and applied to the graphite 22. Again, no adhesive is used. The coated outer glass layer 21, the uncoated inner glass layer 202, a sheet of 0.76 mm PVB plastic interlayer 4, the graphite 22 and the bus bars 20 are assembled. A standard autoclave process is used to laminate the layers.
3. The laminate of embodiment three is illustrated in the exploded view of FIG. 4 and in the top view of FIG. 3. The outer glass layer 201 is comprised of 2.1 mm thick clear soda-lime glass. A conductive layer 24 is formed by a silver based MSVD coating applied to the flat outer glass layer 201 prior to cutting and bending. An abrasive wheel process is used to delete the conductive coating 24 starting at the edge of glass and extending to 6 mm inboard of the edge of glass. The outer glass layer 201 is then cut to size. The inner glass layer 202 is comprised of a flat clear 0.7 mm thick chemically tempered aluminosilicate glass. A black obscuration 6 is applied after lamination on the inner glass layer 202 using an organic ink. The outer glass layer 201 is heated and bent to shape. The inner glass layer 202 is heated and partially bent to shape. A sheet of 50 μm thick graphite 22 is cut to the size of the bus bars 20 plus an additional 6 mm. The cut graphite 22 is then placed in contact with the conductive coating 24. No adhesive is used. A set of bus bars 20 comprised of 0.075 mm thick tinned copper are die cut to shape and applied to the graphite 22. Again, no adhesive is used. The coated outer glass layer 201, the uncoated inner glass layer 202, a sheet of 0.76 mm PVB plastic interlayer 4, the graphite 22 and the bus bars 20 are assembled. A standard autoclave process is used to laminate the layers and to cold bend the inner layer 202.

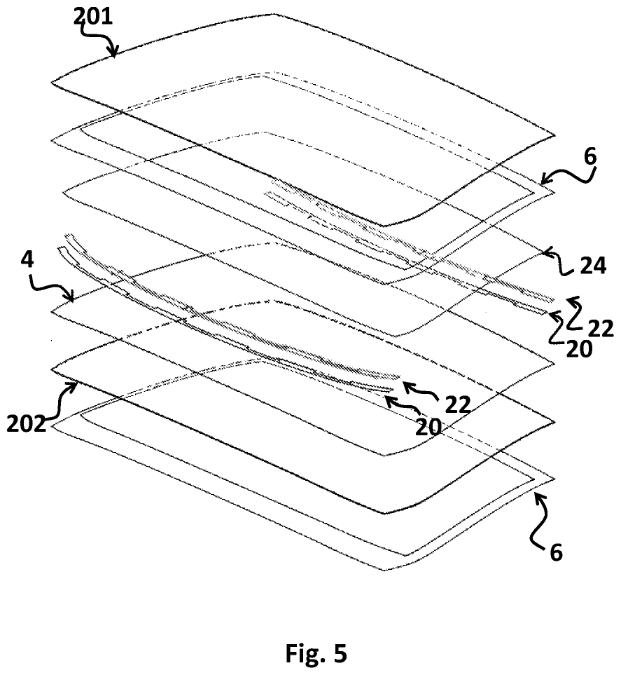

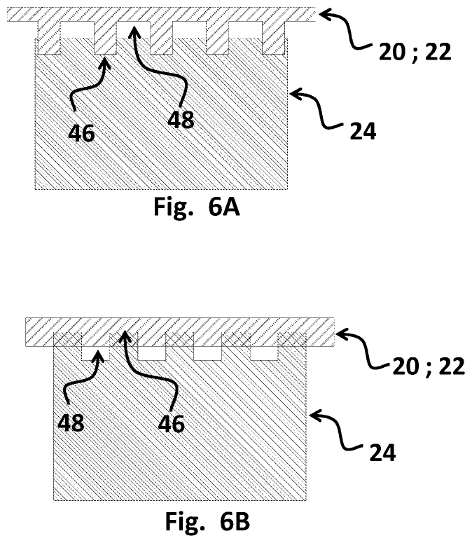

In some of the embodiments, the conductive material and the bus bars 20 are notched as shown in FIG. 5. The dark conductive material 22 and bus bar 20 may be formed in such a manner that the coating 24 is not in contact with them along its entire length. The notched areas do not make contact with the coating 24. The coating has been deleted from the edge of the glass to just past the inner edge of the notches (discontinuities) 48. The tabs 46 bridge the gap and the conductive material make contact with the coating 20 as shown in FIG. 6A.

Another embodiment as shown in FIG. 6B uses a simpler bus bar 20 and a conductive material that are not notched. The discontinuities 48 are formed through deletion of the coating 24, in effect, notching the coating 24 along the bus bars and leaving tabs 46 made of coating. The notches can be formed by a masking process, abrasive deletion or LASER oblation of the coating.

In another embodiment (not shown) the coating 24 and bus bars 20 are not notched. The coating 24 is deleted such that is does overlap or contact the bus bars. The conductive material is notched and is then used to bridge over the gap between the bus bar 20 and the coating 24 and also used to hide the busbar.

In preferred embodiments, thin dark sheets of graphite are used as conductive materials. Graphite has the added advantages of being a good conductor of electricity and an excellent conductor of heat, both of which are important. The graphite also serves to protect the coating from damage from the hard metal bus bars which can result in arcing, hot spots and failure.

1. A laminated glass comprising:
at least two glass layers, an outer glass layer and an inner glass layer;
at least one plastic bonding layer;
at least two bus bars;
at least two thin sheets of a conductive material; and
a transparent conductive layer;
wherein said at least two thin sheets of a conductive material are positioned between the conductive layer and said at least two bus bars; and
wherein said at least two glass layers, said at least two bus bars, said at least two thin sheets of a conductive material and the transparent conductive layer are bonded together to form a laminate by means of said at least one plastic bonding layer.

2. The laminate of claim 1 wherein the conductive material is a form of carbon.

3. The laminate of claim 1 wherein the conductive material is graphite.

4. The laminate of claim 1 wherein at least one of the at least two busbars is modified with discontinuities that break the flow of current from the bus bar to the conductive layer, such that power is not feed along the entire length of said bus bar.

5. The laminate of claim 1 wherein the conductive layer is a conductive coated film.

6. The laminate of claim 1 wherein the inner glass layer is chemically tempered.

7. The laminate of claim 1 wherein the inner glass layer is less than 1 mm thick.

8. The laminate of claim 1 wherein the inner glass layer is cold bent.

9. The laminate of claim 1 wherein the transparent conductive layer is a transparent conductive coating applied to one of the glass layers.

10. The laminate of claim 1 wherein the transparent conductive layer is a plastic film with a transparent conductive coating.
